(19) United States
(12) Patent Application Publication
(10) Pub. No.: US 2025/0260653 A1
(43) Pub. Date: Aug. 14, 2025

(54) SYSTEM AND METHOD FOR DYNAMIC ALLOCATION OF CONTAINER SESSION NETWORK RESOURCES VIA A MACHINE LEARNING MODEL

(71) Applicant: BANK OF AMERICA CORPORATION, Charlotte, NC (US)

(72) Inventors: Elavarasi Mathivanan, Chennai (IN); Pawan Kumar Aila, Hyderabad (IN); Parin H. Sangoi, Glen Mills, PA (US); Daljeet Singh, Plainsboro, NJ (US)

(73) Assignee: BANK OF AMERICA CORPORATION, Charlotte, NC (US)

(21) Appl. No.: 18/438,584

(22) Filed: Feb. 12, 2024

(51) Int. Cl. H04L 47/70; G06N 20/00; H04L 47/80

(52) U.S. Cl. CPC H04L 47/83; G06N 20/00; H04L 47/803

(57) ABSTRACT

Systems, computer program products, and methods are described herein for dynamic allocation of container session network resources via a machine learning model. The present disclosure is configured to receive a request to initiate a container to execute an application model, initiate an application model in the container, input, to a trained machine learning model, input data, determine, from an output of the machine learning model based on the input data, network resource requirements of the container session for running the container, generate a container, and allocate network resources to the container based on the output of the machine learning model.

### TECHNOLOGICAL FIELD

Example embodiments of the present disclosure relate to a system and method for dynamic allocation of container session network resources via a machine learning model.

### BACKGROUND

In the domain of data science platforms, the challenge lies in effectively managing substantial workloads, especially during real-time modifications to high-volume datasets. The reliance on virtual machines and container environments is often inadequate, leading to resource throttling problems, hindered scalability, and suboptimal resource utilization, highlighting the dynamic nature of data processes that demand a more agile and responsive approach for platform efficiency.

Applicant has identified a number of deficiencies and problems associated with the allocation of network resources for executing large models and applications. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for dynamic allocation of container session network resources via a machine learning model.

In one aspect, a system for dynamic allocation of container session network resources via a machine learning model is presented. The system may include a processing device, a non-transitory storage device containing instructions when executed by the processing device, causes the processing device to perform the steps of: train a machine learning model to form a trained machine learning model, receive a request to initiate a container session comprising a container having a containerized version of an application model, input, to the trained machine learning model, input data of at least one selected from the group consisting of: a volume of data to be used by the application model, complexity of the application model, an identifier of a user of the application model, expected runtime of an application model, and performance of the application model, determine, from an output of the machine learning model based on the input data, network resource requirements of the container session for running the container, generate the container session comprising the container, allocate network resources to the container session based on the output of the machine learning model, and initiate the application model in the container session.

In some embodiments, training the machine learning model may include tagging known network resource requirements for the input data to form a dataset, transforming the dataset by preprocessing the dataset, creating a first training set comprising the dataset, and training the machine learning model using the first training set.

In some embodiments, the instructions may further cause the processing device to perform the steps of: monitor the volume of data to be used by the application model.

In some embodiments, the instructions may further cause the processing device to perform the steps of: compare the volume of data to be used by the application model to a predetermined threshold.

In some embodiments, upon a condition where the volume of data to be used by the application model is above the predetermined threshold, the allocated network resources increase.

In some embodiments, upon a condition where the volume of data to be used by the application model is below the predetermined threshold, the allocated network resources decrease.

In some embodiments, the instructions may further cause the processing device to perform the steps of: receive a signal to decommission the container session, deallocate the network resources from the container session, and terminate the container session.

In another aspect, a computer program product for dynamic allocation of container session network resources via a machine learning model is presented. The computer program product may include a non-transitory computer-readable medium comprising code causing an apparatus to: train a machine learning model to form a trained machine learning model, receive a request to initiate a container session comprising a container having a containerized version of an application model, input, to the trained machine learning model, input data of at least one selected from the group consisting of: a volume of data to be used by the application model, complexity of the application model, an identifier of a user of the application model, expected runtime of an application model, and performance of the application model, determine, from an output of the machine learning model based on the input data, network resource requirements of the container session for running the container, generate the container session comprising the container, allocate network resources to the container session based on the output of the machine learning model, and initiate the application model in the container session.

In some embodiments, training the machine learning model may include tagging known network resource requirements for the input data to form a dataset, transforming the dataset by preprocessing the dataset, creating a first training set comprising the dataset, and training the machine learning model using the first training set.

In some embodiments, the code may further cause the apparatus to: monitor the volume of data to be used by the application model.

In some embodiments, the code may further cause the apparatus to: compare the volume of data to be used by the application model to a predetermined threshold.

In some embodiments, upon a condition where the volume of data to be used by the application model is above the predetermined threshold, the allocated network resources increase.

In some embodiments, upon a condition where the volume of data to be used by the application model is below the predetermined threshold, the allocated network resources decrease.

In some embodiments, the code may further cause the apparatus to: receive a signal to decommission the container session, deallocate the network resources from the container session, and terminate the container session.

In yet another aspect, a method for dynamic allocation of container session network resources via a machine learning model is presented. The method may include training a machine learning model to form a trained machine learning model, receiving a request to initiate a container session comprising a container having a containerized version of an application model, inputting, to the trained machine learning model, input data of at least one selected from the group consisting of: a volume of data to be used by the application model, complexity of the application model, an identifier of a user of the application model, expected runtime of an application model, and performance of the application model, determining, from an output of the machine learning model based on the input data, network resource requirements of the container session for running the container, generating the container session comprising the container, allocating network resources to the container session based on the output of the machine learning model, and initiating the application model in the container session.

In some embodiments, training the machine learning model may include tagging known network resource requirements for the input data to form a dataset, transforming the dataset by preprocessing the dataset, creating a first training set comprising the dataset, and training the machine learning model using the first training set.

In some embodiments, the method may further include: monitoring the volume of data to be used by the application model.

In some embodiments, the method may further include: comparing the volume of data to be used by the application model to a predetermined threshold.

In some embodiments, upon a condition where the volume of data to be used by the application model is above the predetermined threshold, the allocated network resources increase.

In some embodiments, upon a condition where the volume of data to be used by the application model is below the predetermined threshold, the allocated network resources decrease.

In some embodiments, the method may further include: receiving a signal to decommission the container session, deallocate the network resources from the container session, and terminate the container session.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the Figures may or may not be present in certain embodiments described herein. Some embodiments may include fewer (or more) components than those shown in the Figures.

FIGS. 1A-1C illustrates technical components of an exemplary distributed computing environment for dynamic allocation of container session network resources via a machine learning model, in accordance with an embodiment of the disclosure;

FIG. 2 illustrates an exemplary machine learning (ML) subsystem architecture 200, in accordance with an embodiment of the disclosure;

FIG. 3 illustrates a flowchart for dynamic allocation of container session network resources via a machine learning model, in accordance with an embodiment of the disclosure;

FIG. 4 illustrates a process flow for dynamic allocation of container session network resources via a machine learning model, in accordance with an embodiment of the disclosure;

FIG. 5 illustrates a process flow for dynamic allocation of container session network resources via a machine learning model, in accordance with an embodiment of the disclosure; and

FIG. 6 illustrates a process flow for dynamic allocation of container session network resources via a machine learning model, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “container” may generally refer to a self-contained and portable unit that encapsulates an application and/or application model alongside its dependencies, libraries, and runtime environment. This container allows for consistent and reproducible deployment across various computing environments by functioning as a standardized package, that abstracts away underlying infrastructure and provides an isolated environment for the application model to operate.

As used herein, a “container session” may generally refer to the active instantiation of a containerized application (i.e., a “container”) within an isolated execution environment. A container session is actively running and utilizing computing resources for the containerized application, and as such may interact with underlying resources such as CPU and memory.

As used herein, a “network resource” may generally refer to any device, system, or component capable of processing and managing information. This may encompass a broad spectrum of hardware and software modules designed to execute computational tasks. Hardware components may include, but are not limited to, central processing units (CPUs), graphics processing units (GPUs), memory modules, storage devices, and networking infrastructure. For software, a network resource may involve operating systems, applications, algorithms, and any code that facilitates the execution of instructions.

In the realm of data science platforms, a pressing challenge arises from the need to effectively manage substantial workloads, encompassing millions of records and terabytes of data daily. The issue is particularly pronounced during real-time modifications to high-volume datasets in the course of data preprocessing and model training of application models. The existing reliance on virtual machines and container environments proves inadequate, leading to network resource throttling problems. Notably, the process of scaling up crucial resources like CPU, memory, and storage during runtime becomes cumbersome, contributing to bottlenecks in system responsiveness. Compounding the challenge is the suboptimal utilization of network resources, especially noticeable when handling smaller workloads. This issue stems from the dynamic nature of data processes and requires a more agile and responsive network resource management approach to enhance the efficiency of data science platforms.

Delving deeper into the problem reveals that the network resource throttling issues stem from the sheer scale and dynamism of data processes. The current infrastructure struggles to cope with the escalating demand for computational (i.e., network) resources as the workload intensifies. The inefficiency becomes more pronounced during runtime adjustments to high-volume datasets, hindering the fluidity and responsiveness of the data science platform.

The solution to the aforementioned shortcomings is presented herein a uses a machine learning model to accurately predict the network resources needed for a container session. By using various inputs, the machine learning model provides the system with the ability to accurately allocate the expected network resources, which not only prevents the waste of these network resources when not needed, but also allows for the application model to be executed within the container session and not be starved of the network resources it needs to execute effectively. Furthermore, the system may monitor the volume of data to be used by the application model to amend (i.e., reduce or increase) the amount of network resources dedicated to the container session. In doing so, dynamic changes to the volume of data to be utilized in the application model will not interrupt the performance of the application model.

Accordingly, the present disclosure embraces a system, computer program product, and method that includes receiving a request to initiate a container session to execute an application model. A trained machine learning model receives input data such as a volume of data to be used by the application model, complexity of the application model, an identifier of a user of the application model, expected runtime of an application model, and performance of the application model. Based on an output from the machine learning model, the network resource requirements of the container are determined. The container is generated, and network resources are allocated to the container session based on the output of the machine learning model.

The training of this machine learning model may be accomplished by tagging known network resource requirements for the input data to form a dataset, transforming the dataset by preprocessing the dataset, creating a first training set comprising the dataset, and training the machine learning model using the first training set.

The volume of data to be used by the application model may be monitored by comparing the volume of data to be used by the application model to a predetermined threshold. When the volume of data is above the predetermined threshold, the allocated network resources may be increased. When the volume of data is below a predetermined threshold, the allocated network resources may be decreased.

Once the container session is no longer needed for the application model, a signal may be received to decommission the container, which leads to the deallocation the network resources from the container session and the termination of the container session.

What is more, the present disclosure provides a technical solution to a technical problem. As described herein, the technical problem includes overcoming resource throttling issues and inefficiencies in managing substantial workloads, especially during real-time modifications to high-volume datasets in data science platforms, caused by the dynamic nature of data processes and limitations in existing infrastructure scalability. The technical solution presented herein allows for the dynamic nature of the data processes to be utilized in predicting the network resources necessary for the data science platforms and monitoring and/or adjusting the allocated network resources in real-time based on workload to prevent unnecessary throttling or wasted network resources. Existing auto-scaling features in container orchestration do not allocate network resources to containers based on user-specific requirements. In particular, using a machine learning model to intake application model characteristics such as the complexity, volume of data to be used, and performance of the application model, is an improvement over existing auto-scaling solutions to the throttling and/or over-allocation of network resources, (i) with fewer steps to achieve the solution, thus reducing the amount of network resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving network resources, (iv) determining an optimal amount of resources that need to be used to implement the solution, thus reducing network traffic and load on existing network resources. Furthermore, the technical solution described herein uses a rigorous, computerized process to perform specific tasks and/or activities that were not previously performed. In specific implementations, the technical solution bypasses a series of steps previously implemented, thus further conserving network resources.

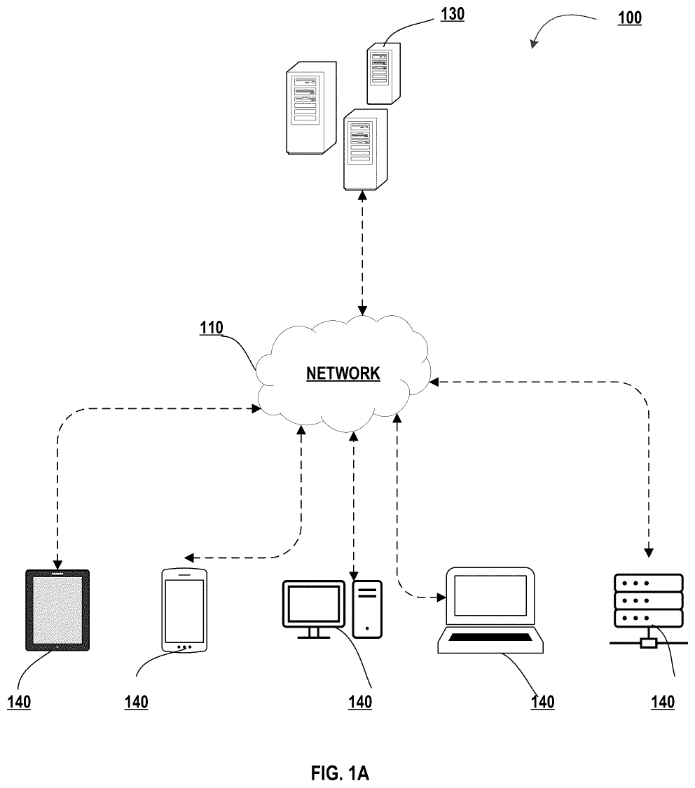

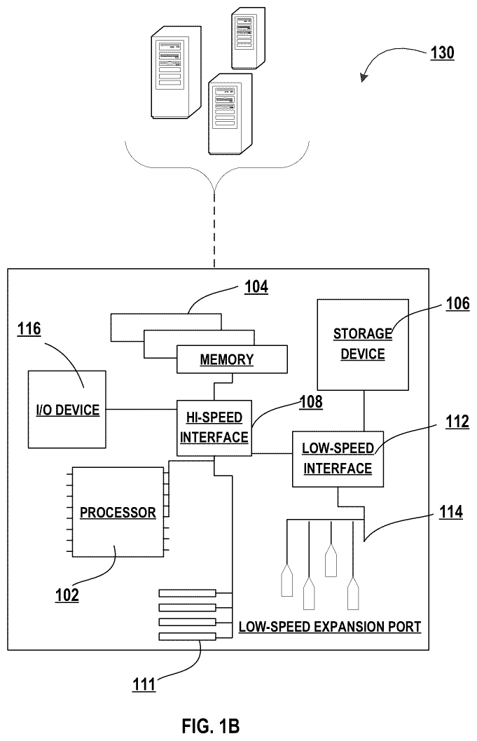

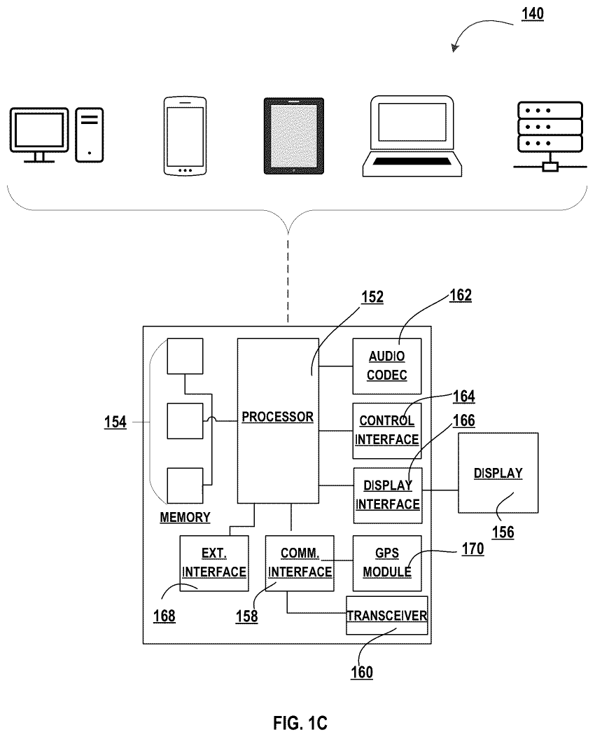

FIGS. 1A-1C illustrate technical components of an exemplary distributed computing environment 100 for dynamic allocation of container session network resources via a machine learning model, in accordance with an embodiment of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the endpoint device(s) 140 may have a client-server relationship in which the endpoint device(s) 140 are remote devices that request and receive service from a centralized server, i.e., the system 130. In some other embodiments, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low speed bus 114 and storage device 106. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an embodiment of the disclosure. As shown in FIG. 1C, the endpoint device(s) 140 includes a processor 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the endpoint device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the endpoint device(s) 140, such as control of user interfaces, applications run by endpoint device(s) 140, and wireless communication by endpoint device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some embodiments, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location—related wireless data to endpoint device(s) 140, which may be used as appropriate by applications running thereon, and in some embodiments, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some embodiments, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

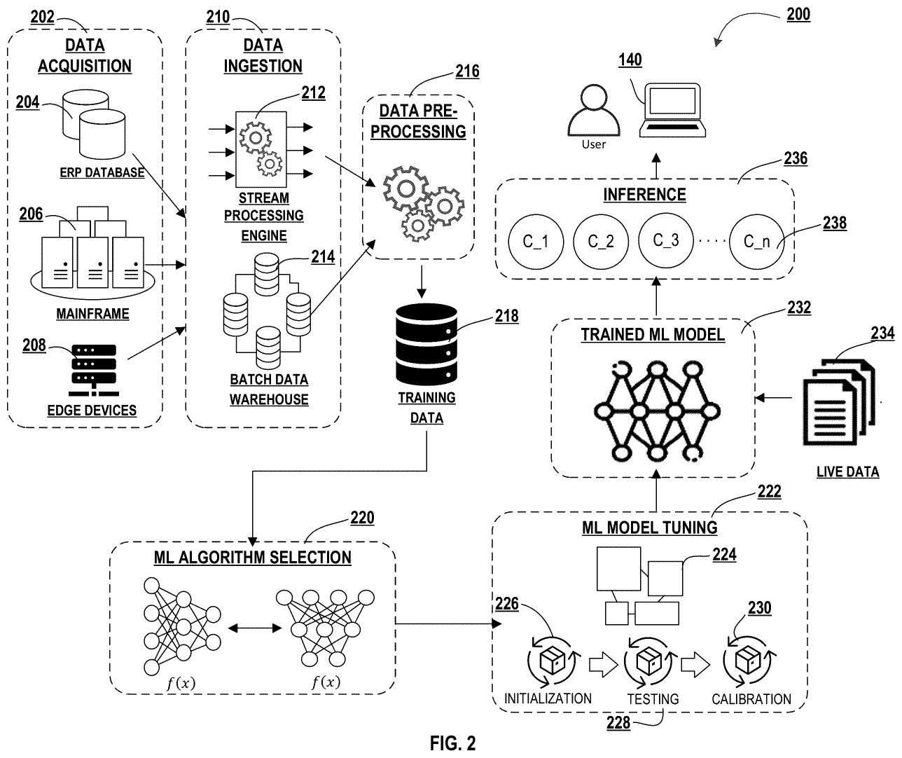

FIG. 2 illustrates an exemplary machine learning (ML) subsystem architecture 200, in accordance with an embodiment of the disclosure. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model to form a trained machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the embodiment of the machine learning subsystem 200 illustrated in FIG. 2 is exemplary and that other embodiments may vary. As another example, in some embodiments, the machine learning subsystem 200 may include more, fewer, or different components.

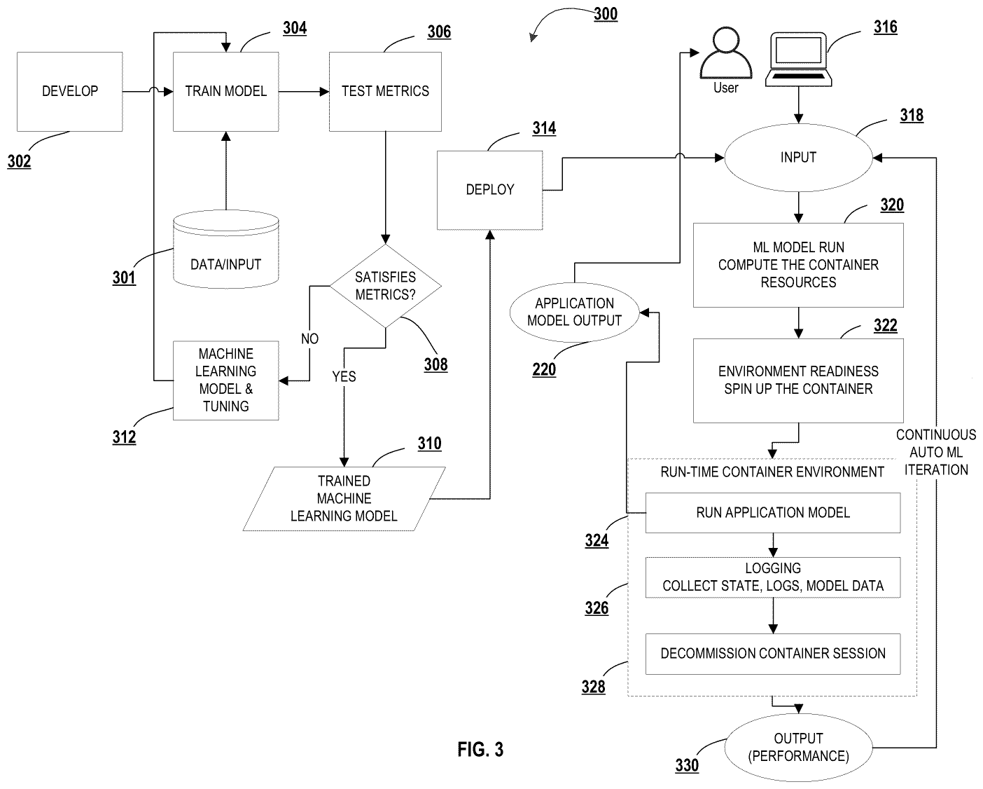

FIG. 3 illustrates a flowchart 300 for dynamic allocation of container session network resources via a machine learning model, in accordance with an embodiment of the disclosure. While much of the detail of the present disclosure will be described in detail with respect to FIGS. 4-6, FIG. 3 provides an overview of the processes and various interdependencies between the machine learning model and the application model.

As illustrated in FIG. 3, the machine learning model that will be developed in block 302 and trained in block 304 is the machine learning model which will ultimately be deployed to estimate the network resources required for a container of an application model. The data input 301 that will be used to train the model may include logs of prior network resource usage of application model(s) and their characteristics (such as the type of application model, the volume of input data, the user identifier, or the like). Test metrics 306 may be used to determine the accuracy of the machine learning model, such that if the metric is satisfied in block 308, the machine learning model is considered trained as shown in block 310. Otherwise, the machine learning model may require additional tuning of various parameters in block 312 and additional testing and comparison to test metrics.

Once the machine learning model is trained, it is deployed in the network as shown in block 314. Within the network, a user may interact with endpoint device(s) 140 to request that an application model be executed in a container session. Thus, as shown in block 318, information from the request, such as the user identifier, model type, volume of data, and so forth may be used as in input. The machine learning model (e.g., the trained machine learning model in block 310) is deployed and the container resources (e.g., the network resources) are computed. In block 322, the container is generated (e.g., “spun up”), and the application model is executed. During the execution of the application model in block 324, logging occurs in block 326, to collect the state, status, model data, and other logs of the application model during the execution within the container session. Specifically, runtime logs may be collected to account for the memory usage and computation time of the application model. Error analysis logs may be collected to identify any network resource shortage or abundance. Validation logs may be collected to evaluate the generalization performance of the application model. Input and output logs may be recorded to determine the input data into the application model.

These logs contain valuable information which may be used to further refine the machine learning model to better predict the network resources required for any given application model. Accordingly, in some embodiments, once the container session is decommissioned, these logs are provided to the machine learning model as training data for backpropagation techniques. In doing so, parameters, hyperparameters are tuned for accuracy. Additionally, or alternatively, in some embodiments, the logs of block 326 may be continuously collected during the execution of the application model, and provided to the machine learning model for training in real time in addition to or instead of after the decommissioning of the container session.

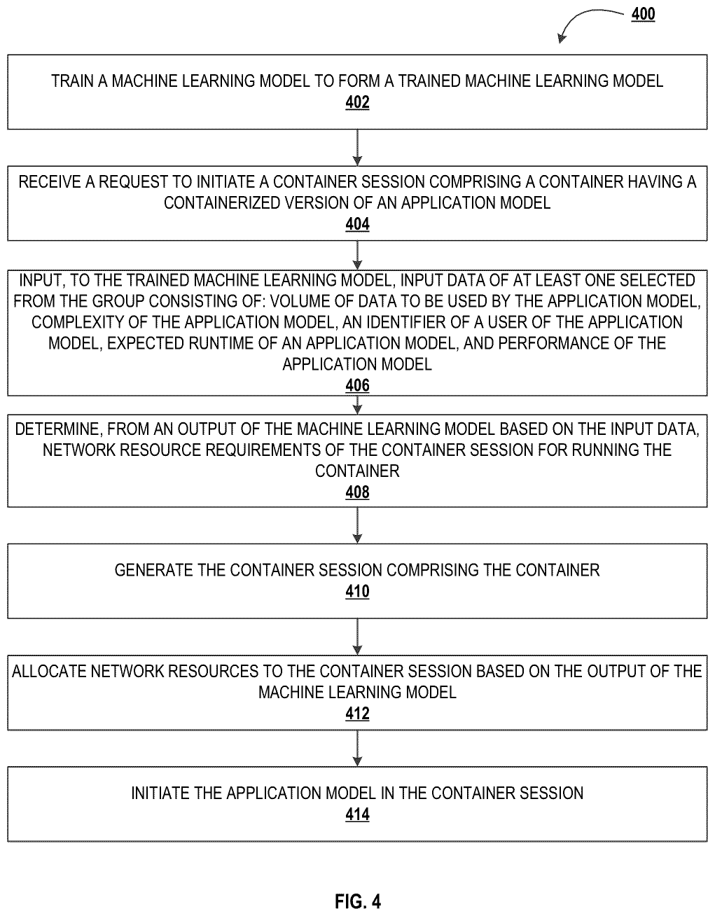

FIG. 4 illustrates a process flow for dynamic allocation of container session network resources via a machine learning model, in accordance with an embodiment of the disclosure.

As used herein, a “machine learning model” may refer specifically to the machine learning model 232 trained to provide an output of estimated network resources required. On the other hand, an “application model” as used herein may refer to a specific computer model chosen by a user to be deployed within a container. Accordingly, many “application models” may also comprise various types of machine learning models, the functions and intricacies of which are not critical to the functionality of the present disclosure. Indeed, data scientists and other users may explore data using numerous types of application models, including supervised and unsupervised learning models, deep learning models, reinforcement learning models, ensemble models, and so forth. It shall be appreciated that such “application models” generally consume a large amount of network resources, and as such a container session of the appropriate size is desired to be estimated by the “machine learning model.” Various application models may be used to extract insights from complex datasets. One aspect is the use of statistical analysis tools to facilitate data cleaning, exploration, and basic statistical operations. Visualization tools may be used to represent data patterns graphically to aid in the interpretation of complex relationships. Machine learning frameworks may be implemented using various models, including regression, classification, and clustering algorithms. Additionally, natural language processing (NLP) models, such as those based on transformers may be implemented for text analysis and understanding. Furthermore, specialized models like recommendation systems and anomaly detection models cater to specific data science needs.

The process may begin at block 402, where a machine learning model is trained. In some embodiments, the machine learning model may be trained during a process not executed by the present system 130, thus block 402 may be omitted entirely, and instead the trained machine learning model 232 that results from said training is implemented throughout the remainder of the disclosure. In other embodiments, however, the machine learning model may be trained using various techniques illustrated with respect to FIG. 2 above, and continuously provided feedback (e.g., backpropagation) through various data as will be discussed in greater detail herein. Such training techniques may include process steps such as tagging known network resource requirements for the input data to form a dataset.

The type of input data that may ultimately be provided to the machine learning model 232 includes, but is not limited to, a volume of data to be used by the application model, complexity of the application model, an identifier of a user of the application model, expected runtime of the application model, and performance of the application model.

The volume of data for any of the aforementioned application models may be specified based on the specific application model to the implemented. In some embodiments, the volume of data input data received by the machine learning model 232 may be input by a user. For example, dataset sizes may be categorized into categories—small, medium, and large. Small datasets may include a few hundred to a few thousand data points, while medium-sized datasets may range from several thousand to tens of thousands of data points. Large datasets may include tens of thousands to millions of data points. Of course, other schemes for categorization are contemplated, including numerical scales, such as from 1 to 5, 1 to 10, 1 to 100, and so forth. In other embodiments, the volume of data is retrieved based on an identified data input to the application model prior to containerization.

Input data including the complexity of the application model may also be provided. In some embodiments, the complexity of the application model may be determined by a user. As a non-limiting example, the application model may be categorized as simple, moderate, or complex based on the intricacy of the underlying algorithms. For example, simple application models may use linear regression and basic decision trees, moderate complexity application models may be those such as support vector machines and random forests, and complex application models may be those that use deep neural networks in large and high-dimensional datasets. Alternatively, the complexity of the application model may be measured (e.g., counted) by the system 130 using framework specific functions to collect the number of parameters or layers in the neural networks of the application model.

In some embodiments, the expected runtime of the application model may be specified by a user as input data, such as runtimes ranging from 0 to 1 minute, 1 to 2 minutes, 3 to 5 minutes, 5 to 10 minutes, 10 to 30 minutes, 30 to 60 minutes, and so forth. Alternatively, categories of run time may be used such as short, moderate, and long, or variations thereof, as predetermined in the system 130 by a user.

In some embodiments, the performance of the application model may also be provided to the machine learning model 232 as input data, through various metrics. These metrics may include at least one of Mean Squared Error (MSE), which quantifies the average squared difference between predicted and actual values and provides a measure of the model's accuracy in regression tasks, Mean Absolute Error (MAE), another regression metric, which calculates the average absolute difference between predicted and actual values, offering a more interpretable assessment of prediction accuracy, R-squared (R²) which evaluates how well the model's predictions align with the variability in the actual data, with higher values indicating a better fit, the Area Under the Receiver Operating Characteristic Curve (AUC-ROC) which assesses a model's ability to distinguish between positive and negative instances, especially in binary classification, the Area Under the Precision-Recall Curve (AUC-PR) which focuses on precision and recall in imbalanced datasets, Cohen's Kappa, which measures agreement between predicted and actual labels, adjusting for chance, and/or Log Loss (Logarithmic Loss), which evaluates the accuracy of predicted probabilities in classification, with lower values indicating better performance in probabilistic scenarios.

In some embodiments, a user identifier (i.e., an identifier of a user, or “ID”), for example an alphanumeric identifier unique to a given user or endpoint device(s) 140, may be provided as input data to the machine learning model 232. In this way, other input data may be associated with the user identifier within the machine learning model 232 to better estimate the network resources required for a given container session, and the estimate will be user-specific based on the typical requirements of a given user who may be accustomed to executing larger application models than other users, or smaller application models, and so forth.

For example, some users may choose to build their models using tools, libraries, and frameworks that are more resource-intensive than others. Additionally, or alternatively, some users may use different parallelization strategies in their application model, thus requiring different levels of network resources than other users. Additionally, or alternatively, some users may have different hardware than other users. Thus, user identifiers associated with these types of users may be subject to additional network resources or fewer network resources as an output of the machine learning model 232, as compared to other users. In this way, the output of the machine learning model 232 is user specific.

In furtherance of training the machine learning model, the dataset to train the machine learning model may first be transformed by preprocessing. In some embodiments, the preprocessing may include data cleaning, where missing values may be rectified, outliers identified and removed, and any inconsistencies or errors are rectified. Additionally, or alternatively, in some embodiments, feature scaling may be implemented to normalize the range of numerical features and ensure that no single variable dominates the learning process. Additionally, or alternatively, in some embodiments, dimensionality reduction techniques, including but not limited to, principal component analysis (PCA), may be implemented to extract the most informative features. Additionally, or alternatively, in some embodiments, categorical variables may be encoded into a format suitable for processing, either through one-hot encoding or label encoding. Additionally, or alternatively, in some embodiments, imbalanced datasets may be resampled.

In some embodiments, the machine learning model may be subject to supervised learning, such that the machine learning model 232 is trained to learn the relationship between input features and corresponding output labels. Thus, the preprocessed dataset may be provided alongside corresponding labeled outputs, collectively as the first training set, such as the amount of network resources required given the various input data provided as features.

In other embodiments, the machine learning model may be subjected to unsupervised learning, such as clustering or dimensionality reduction, and thus may not require labeled data. Indeed, the preprocessing of a dataset results in the first training set, and the model determines patterns or structures within the data without predefined output categories.

Once the trained machine learning model 232 is available, the process may then continue at block 404, where the system 130 receives a request to initiate a container session comprising a container having a containerized version of an application model. In traditional systems, the request may trigger a container orchestration system to allocate the necessary resources. However, the present disclosure embraces a system 130 of determining these necessary resources via a machine learning model 232. Thus, the process may proceed at block 406.

At block 406, the system 130 receives input, to the trained machine learning model 232, input data of at least one selected from the group consisting of: a volume of data to be used by the application model, complexity of the application model, an identifier of a user of the application model, expected runtime of the application model, and performance of the application model, each of which has been defined in detail herein. In some embodiments, the input data is provided by a user who is initiating the container session. Alternatively, the input data may be associated with the application model to be containerized, such that the request to initiate the container session contains a name or identifier of a container image, the dependencies of the application model, and so forth. Accordingly, input data regarding the container image based on the name or identifier may be available to the machine learning model 232 by retrieving the input data from a database of a repository based on the name or identifier of the container image.

Next, at block 408, the system 130 may determine from an output of the machine learning model 232, based on the input data, the network resource requirements of the container session (e.g., the network resources required for the container session). Input data may be provided to the machine learning model 232, and subsequently resulting in a predicted output of the computing requirements, which are quantified network resource usage estimates for the container session. In some embodiments, the machine learning model 232 may output CPU usage metrics, such as the percentage of CPU cycles estimated to be consumed by the container. Additionally, or alternatively, memory usage may be estimated, either in absolute bytes or as a percentage of total available memory. Additionally, or alternatively, monitoring disk I/O, represented by read and write operations per second (IOPS), may be estimated by the machine learning model 232. Additionally, or alternatively, tracking network I/O in terms of data transfer rate may be estimated by the machine learning model 232.

Next, at block 410, the system 130 may generate a container session. In some embodiments, a designated container image (i.e., the container) containing the application code, dependencies, and runtime environment, is retrieved from the repository. It shall be appreciated that in some embodiments, the system 130 at block 410 may generate a container session with a predetermined network resource allocation prior to the processes outlined at block 412. In other embodiments, system 130 at block 410 may generate a container session with the network resource allocation outlined at block 412 (e.g., as the output of the machine learning model 232). In yet additional embodiments, the processes in block 410 and 412 may be completed in parallel (i.e., at the same time, or overlapping in time).

Next, at block 412, the system 130 may allocate network resources to the container session based on the output of the machine learning model 232. At block 414, the system 130 initiates the application model in the container session. Once the container session is initialized, the specified application model is executed within this encapsulated environment, using at least a portion of the allocated network resources.

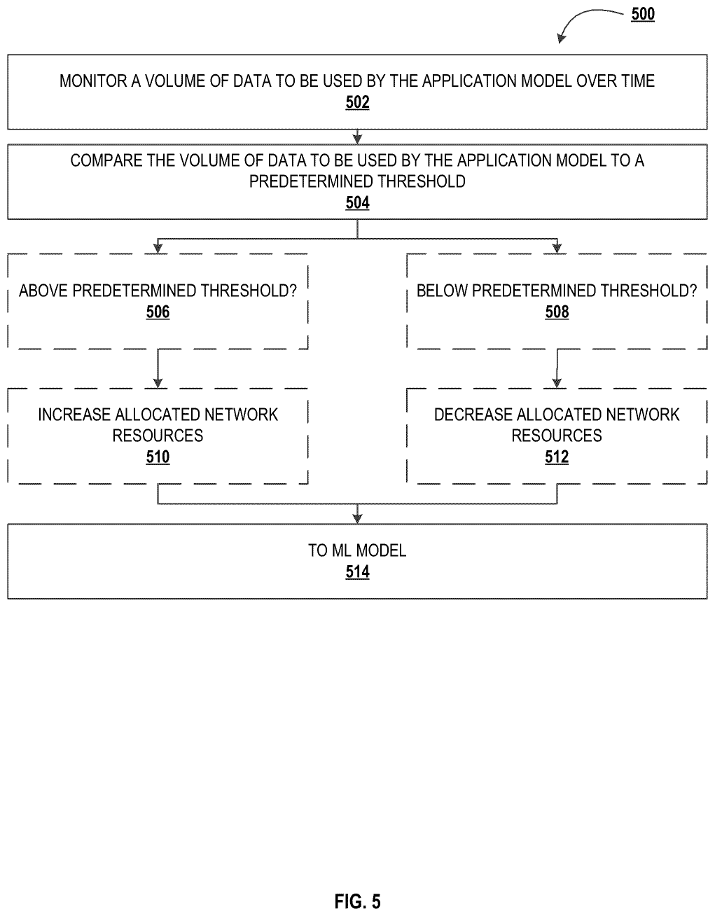

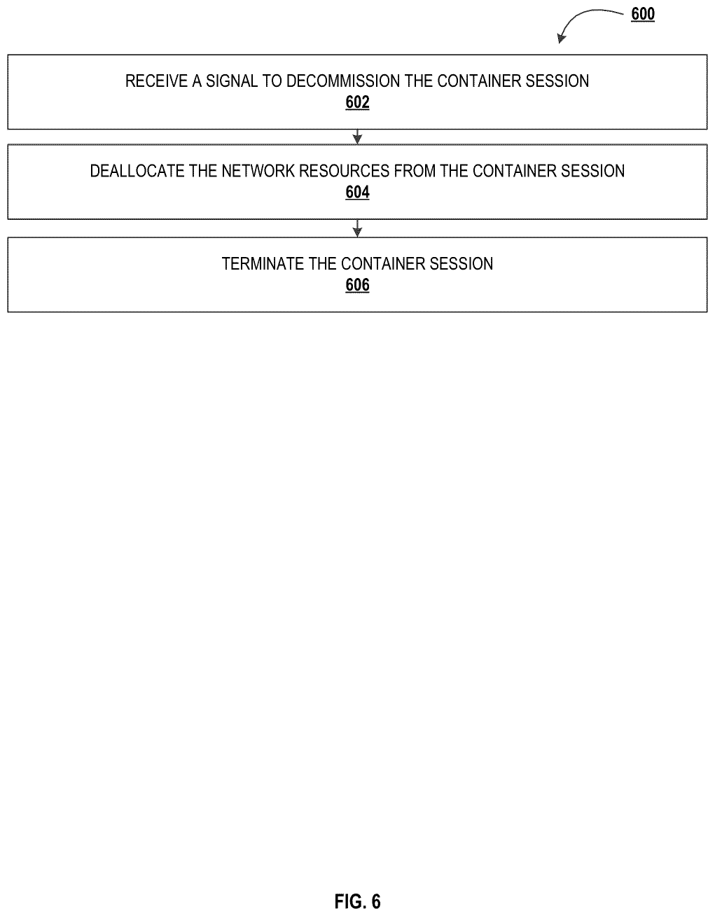

FIG. 5 illustrates a process flow for dynamic allocation of container session network resources via a machine learning model, in accordance with an embodiment of the disclosure. It shall be appreciated that in certain embodiments, the process steps outlined in FIG. 5 may occur after those of FIG. 4. However, in other embodiments, this sequential relationship is not obligatory, and the process steps of FIG. 5 may occur at other point within those of FIG. 4. Similarly, the process steps outlined in FIG. 6 may be executed at any point between blocks illustrated in FIG. 4 and/or FIG. 5.

It shall also be appreciated that a containerized application model may require more network resources than initially estimated by the machine learning model 232. Additionally, or alternatively, the containerized application model may require fewer network resources than initially estimated by the machine learning model 232. Such adjustments may be necessary due to the dynamic nature of the volume of data to be used by the application model. As used herein, a “volume of data” may refer generally to the amount of data to be utilized by the application model, changes to which result in changes to the network resources required by the application model.

For example, the application model may load data dynamically, where it fetches new data from external data sources or receives streaming data as an input. Fluctuations in the size of such data has an impact on the required network resources for the containerized application model. Additionally, or alternatively, if the application model engages in machine learning or deep learning, updates to the application model during training could alter the volume of data based on changes to the application model parameters, weights, and so forth.

Thus, one object of the process flow illustrated in FIG. 5 is to provide for ongoing analysis of the network resources predicted to be used by the containerized application model by the machine learning model 232. In some embodiments, the overestimation or underestimation may be a result of an inaccurate estimation on the part of the machine learning model 232. Thus, the output of the monitoring in FIG. 5 may be used as data for backpropagation in refining the parameters of the machine learning model 232. Continuous training of the machine learning model 232 may include adjusting weights through this backpropagation.

At block 502, the system 130 monitors the volume of data to be used by the container over time. This may include a retrieval of the size of the data (for example, in megabytes, kilobytes, gigabytes, terabytes, or the like), and/or the data transmission rate (for example, megabytes per second, kilobytes per second, gigabytes per second, terabytes per second, or the like).

Next, at block 504, the system 130 compares the volume of data which is received from the monitoring in block 502 to a predetermined threshold. This predetermined threshold may be implemented as a fixed percentage of the volume of data over or under a volume of data output from the machine learning model 232, or in some embodiments it may be implemented as a gross amount of volume of data below or above the volume of data output of the machine learning model 232.

For example, a predetermined threshold of a volume of data to be used by an application model may be set at 2 Terabytes, as may have been predetermined to be initially expected for the application model. However, during the containerization process, the volume of data to be used by the application model may have increased unexpectedly to 3 Terabytes. Thus, the system compares 3 Terabytes to 2 Terabytes and determines that the actual volume of data to be used by the application model is higher than the predetermined threshold.

As illustrated in block 506, after comparing the monitored information to the predetermined threshold, the system 130 may take certain remedial actions. Upon a condition where the volume of data to be used by the application model is above the predetermined threshold, the system 130 may allocate additional network resources to the container session, thus increasing the amount of network resources available, as shown in block 510. Alternatively, as shown in block 508, upon a condition where the volume of data to be used by the application model is below the predetermined threshold, the system 130 may decrease the amount of network resources available, as shown in block 512.

The system 130 may reduce or increase the network resources allocated to the container session by a predetermined percentage. For example, the network resources allocated to the container may be increased by 10%, or 15%, or 20%, or 25%, or 50%, and so forth, should the volume of data be above the predetermined threshold. Similarly, for example, the network resources allocated to the container may be decreased by 10%, or 15%, or 20%, or 25%, or 50%, and so forth, should the volume of data be below the predetermined threshold.

In other embodiments, the amount of increase or decrease of allocated network resources may be as a predetermined unit. For example, for CPU usage, a predetermined percentage of increase or decrease may be defined. For memory usage, a predetermined number of bytes, kilobytes, megabytes, or gigabytes, may be defined. For disk I/O, a predetermined amount read and write operations per second (IOPS) may be defined. For network I/O, a predetermined number of kilobits or megabits per second may be defined.

As illustrated in block 514, the output of the analysis of the volume of data to be used by the application model, and any data of the volume of data used during the runtime may be provided as a training input to the machine learning model 232 to refine the machine learning model.

FIG. 6 illustrates a process flow for dynamic allocation of container session network resources via a machine learning model, in accordance with an embodiment of the disclosure. Once the application model has been executed and it is no longer necessary to maintain a container session for the application model, the system 130 as shown in block 602, may receive a signal to decommission the container. The signal may be provided by a user through the user interface, or in some embodiments, the signal may be generated as a result of the container session no longer using any network resources (as would be determined using the processes illustrated in FIG. 5, should the predetermined threshold be set at a minimum, and the volume of data falls below said predetermined threshold).

Once the signal to decommission has been received, the system 130 deallocates the network resources from the container, and shown in block 604, and terminates the container, as shown in block 606. In this way, the allocated network resources are now unallocated, able to be reallocated to other container sessions throughout the computer network. In some embodiments, the system 130 may collect the logs and user data during the decommissioning of the container session, and the output will be passed on to the machine learning model 232 as training data. These logs may include and increase or decrease in the amount of the network resources necessary, the total runtime of the application model, and so forth.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for dynamic allocation of container session network resources via a machine learning model, the system comprising:
a processing device;
a non-transitory storage device containing instructions when executed by the processing device, causes the processing device to perform the steps of:
train a machine learning model to form a trained machine learning model;
receive a request to initiate a container session comprising a container having a containerized version of an application model;
input, to the trained machine learning model, input data of at least one selected from the group consisting of: a volume of data to be used by the application model, complexity of the application model, an identifier of a user of the application model, expected runtime of an application model, and performance of the application model;
determine, from an output of the machine learning model based on the input data, network resource requirements of the container session for running the container;
generate the container session comprising the container;
allocate network resources to the container session based on the output of the machine learning model; and
initiate the application model in the container session.

2. The system of claim 1, wherein training the machine learning model comprises:
tagging known network resource requirements for the input data to form a dataset;
transforming the dataset by preprocessing the dataset;
creating a first training set comprising the dataset; and
training the machine learning model using the first training set.

3. The system of claim 1, wherein the instructions further cause the processing device to perform the steps of:
monitor the volume of data to be used by the application model.

4. The system of claim 3, wherein the instructions further cause the processing device to perform the steps of:
compare the volume of data to be used by the application model to a predetermined threshold.

5. The system of claim 4, wherein upon a condition where the volume of data to be used by the application model is above the predetermined threshold, the allocated network resources increase.

6. The system of claim 4, wherein upon a condition where the volume of data to be used by the application model is below the predetermined threshold, the allocated network resources decrease.

7. The system of claim 1, wherein the instructions further cause the processing device to perform the steps of:
receive a signal to decommission the container session;
deallocate the network resources from the container session; and
terminate the container session.

8. A computer program product for dynamic allocation of container session network resources via a machine learning model, the computer program product comprising a non-transitory computer-readable medium comprising code causing an apparatus to:
train a machine learning model to form a trained machine learning model;
receive a request to initiate a container session comprising a container having a containerized version of an application model;
input, to the trained machine learning model, input data of at least one selected from the group consisting of: a volume of data to be used by the application model, complexity of the application model, an identifier of a user of the application model, expected runtime of an application model, and performance of the application model;
determine, from an output of the machine learning model based on the input data, network resource requirements of the container session for running the container;
generate the container session comprising the container; and
allocate network resources to the container session based on the output of the machine learning model and
initiate the application model in the container session.

9. The computer program product of claim 8, wherein training the machine learning model comprises:
tagging known network resource requirements for the input data to form a dataset;
transforming the dataset by preprocessing the dataset;
creating a first training set comprising the dataset; and
training the machine learning model using the first training set.

10. The computer program product of claim 8, wherein the code further causes the apparatus to:
monitor the volume of data to be used by the application model.

11. The computer program product of claim 10, wherein the code further causes the apparatus to:
compare the volume of data to be used by the application model to a predetermined threshold.

12. The computer program product of claim 11, wherein upon a condition where the volume of data to be used by the application model is above the predetermined threshold, the allocated network resources increase.

13. The computer program product of claim 11, wherein upon a condition where the volume of data to be used by the application model is below the predetermined threshold, the allocated network resources decrease.

14. The computer program product of claim 8, wherein the code further causes the apparatus to:
receive a signal to decommission the container session;
deallocate the network resources from the container session; and
terminate the container session.

15. A method for dynamic allocation of container session network resources via a machine learning model, the method comprising:
training a machine learning model to form a trained machine learning model;
receiving a request to initiate a container session comprising a container having a containerized version of an application model;
inputting, to the trained machine learning model, input data of at least one selected from the group consisting of: a volume of data to be used by the application model, complexity of the application model, an identifier of a user of the application model, expected runtime of an application model, and performance of the application model;
determining, from an output of the machine learning model based on the input data, network resource requirements of the container session for running the container;
generating the container session comprising the container; and
allocating network resources to the container session based on the output of the machine learning model; and
initiating the application model in the container session.

16. The method of claim 15, wherein training the machine learning model comprises:
tagging known network resource requirements for the input data to form a dataset;
transforming the dataset by preprocessing the dataset;
creating a first training set comprising the dataset; and
training the machine learning model using the first training set.

17. The method of claim 15, wherein the method further comprises:
monitoring the volume of data to be used by the application model.

18. The method of claim 17, wherein the method further comprises:
comparing the volume of data to be used by the application model to a predetermined threshold.

19. The method of claim 18, wherein upon a condition where the volume of data to be used by the application model is above the predetermined threshold, the allocated network resources increase.

20. The method of claim 15, wherein the method further comprises:
receiving a signal to decommission the container session;
deallocating the network resources from the container session; and
terminating the container session.
